(19) United States
(12) Patent Application Publication
(10) Pub. No.: US 2010/0191587 A1
(43) Pub. Date: Jul. 29, 2010

(54) TRANSACTION SYSTEM FOR CHARITABLE FUND RAISING, WITH TAX BENEFIT

(76) Inventor: Donald Jeffrey Duerr, Pinedale, WY (US)

Correspondence Address: GREENBERG & LIEBERMAN, LLC, 2141 WISCONSIN AVE, N.W., SUITE C-2, WASHINGTON, DC, 20007, US

(21) Appl. No.: 12/693,298

(22) Filed: Jan. 25, 2010

Related U.S. Application Data
(60) Provisional application No. 61/146,715, filed on Jan. 23, 2009.

(51) Int. Cl. G06Q 40/00; G06Q 20/00; G06Q 10/00; G06Q 30/00; G06Q 50/00; G06F 15/16

(52) U.S. Cl. 705/14.7; 705/17; 705/26; 705/31; 705/34; 705/37; 705/38; 705/41; 705/329; 709/204

(57) ABSTRACT

A system for using financial transactions to raise funds for charitable purposes. A party who uses the system for carrying out financial transactions agrees to pay fee-like contributions for use of the system, such that a portion (up to 100%) of a contribution will be allocated to a charitable entity on behalf of the user. A business entity that facilitates the financial transactions records the details of the transactions and then reports to each user the charitable contribution the user has made through the system. This allows the users to obtain tax benefits on their respective contributions.

### CONTINUITY DATA

This is a non-provisional application claiming priority to U.S. provisional patent application No. 61/146,715 filed on Jan. 23, 2009.

### FIELD OF THE INVENTION

The present invention relates to a financial transaction system that raises funds for charitable purposes through fee-like contributions made by the parties who use the system. The invention has accounting, allocation and reporting means making it possible for users to receive a tax benefit on their respective contributions.

### BACKGROUND OF THE INVENTION

A shortage of funding to carry out charitable programs is a common barrier blocking progress on the resolution of many pressing global, regional, and local problems. For instance, millions of children around the world die each year from diseases that are preventable or readily treatable. These and many other lives could be saved if more funds were made available for charitable efforts to provide people in need with basic medicines and water purification systems. Likewise, when a natural disaster occurs, many people require emergency relief, yet charitable relief efforts are often impeded by lack of funding. The same is true of wildlife conservation: the amount of habitat that can be protected generally depends on how much charitable funding is made available for this purpose.

The present invention allows revenues to be gathered from fee-like contributions paid by those who participate in financial transactions and then allocates the revenues for charitable purposes.

For example, in existing credit card transaction systems, when a person (i.e., cardholder) uses a card to make a purchase, that person may have paid an annual “card use” or “membership” fee for the privilege of using the card for a one year period, and the cardholder may also pay interest or late payment fees on the purchase itself In addition, a transaction fee (also known as a merchant discount fee or blended rate fee) is generally paid by the merchant on the purchase. The invention allows the payment of such fees to become charitable contributions made by the participants in the transactions.

Some existing financial companies currently issue “affinity” credit cards that generate some funding for charitable purposes. In these transaction systems, whenever a purchase is made using an affinity card, the company that issued the credit card contributes a small portion (typically 50 basis points or one-half of 1% of the total transaction value) to a charitable organization affiliated with the affinity program. For example, on a $100 transaction the resulting charitable contribution may amount to $0.50. In contrast, the card issuer may collect $3 from the transaction fee paid by the merchant and $7 in interest charges paid by cardholder on that purchase. The card issuer may also reap substantial additional revenues from the same cardholder from annual card use fees, late payment fees, and cash advance fees. Looking at all transactions carried out by a single affinity cardholder, the card issuer may reap over $200 in revenues each year from the various fees paid by the cardholder who uses the transaction system, while just $10-20 may be allocated for the charity named on the card. Generally speaking, the small amounts of funding generated for the charity in the affinity system are more than offset by the higher fees charged on the affinity credit card. For these reasons, some financial experts have advised consumers to avoid using affinity cards.

The present invention represents a significant improvement over the traditional affinity card fund raising system by allowing more charitable funds to be generated from a wide variety of fees collected on transactions. These fees include, but are not limited to, credit cardholder interest fees, annual card use fees, late payment fees, cash advance fees, balance transfer fees, over-limit fees, debit card transaction fees, debit card “foreign” or out-of-network ATM fees, debit card overdraft fees, international transaction fees, convenience fees, card replacement fees, merchant transaction fees (e.g., merchant discount fees or blended rate fees, which may include card issuer interchange fees and acquirer network use fees), and merchant charge back fees. Billions of financial transactions are carried out around the world each year. Using the present invention to capture a modest amount of revenue from a variety of fees assessed on a large number of transactions has the potential to generate a large amount of charitable funding.

The parties (e.g., consumers and merchants) who sign up to use the present invention transaction system—as well as the business means facilitating the transactions—all agree that a set of fees paid on transactions will be used as contributions to charitable efforts. This allows a participant to raise funds for the charitable purpose through ordinary day-to-day financial transactions that are not associated with the charity. A party making use of this transaction system described herein may generate upwards of $100-200 per year for charitable purposes—10-20 times more than might be generated by using a traditional affinity credit card system subject to comparable fees. The party can therefore contribute more to charitable efforts without having to spend more than would have been spent paying comparable fees to a card issuer that does not use this invention.

In short, this novel charitable fund raising system is more effective than traditional affinity card fund raising systems. The participants derive a significant benefit in knowing greater proportions of the fees they do pay on transactions will be used for charitable purposes.

A second area of improvement of the present invention relates to tax benefits. In the U.S., interest payments made on credit card loans are not tax deductible. This differs from the interest payments made on other kinds of loans, such as house mortgages, which are eligible for tax deduction benefits. Other kinds of transaction fees (e.g., annual card use fees, late payment fees, cash advance fees, etc.) also are not tax deductible. The present invention allows people who use the charitable transaction system to obtain tax deduction benefits from the payments they make on such fees because the payments will be used as contributions for charitable purposes. This tax benefit is not available with affinity cards or any other existing payment card system. In particular, when donations are made to charitable programs through an affinity card, the cardholder cannot claim any tax benefit because the cardholder does not make any actual donation to a charitable organization. Instead, the company that issued the affinity card makes the donations. Therefore, in traditional affinity card systems, only the card issuing company can obtain a tax benefit. For the average U.S. cardholder, the tax benefit offered by the improved charitable transaction system embodied in this invention may exceed $100 per year and in some cases (e.g., when cardholders maintain high outstanding balances) the benefit may exceed $1000 per year. Even people who rarely donate to charitable efforts will be inclined to use the charitable transaction system embodied in this invention because of the tax benefit. In so doing, even these individuals will end up contributing to worthwhile efforts they may not otherwise support.

### SUMMARY OF THE INVENTION

The present invention relates to a method of raising charitable funding through a financial transaction system. Users of the transaction system agree to make fee-like contributions associated with their use of the system, such that portions (which may be up to 100%) of the contributions will be allocated for charitable purposes on behalf of the user. The invention includes accounting means to tally all charitable contributions made by each user, and it also uses means to report, to the each user, the portions of such contributions that are tax deductible. Thus, the present invention allows those who engage in financial transactions to make charitable contributions and to receive tax benefits through fee-like payments that would not otherwise be eligible for these benefits. The present invention can facilitate a variety of transaction types while achieving the charitable fund raising and tax benefit advantages. Examples are, but are not limited to, credit card transactions, debit card transactions, on-line (internet) financial transactions, bank wire transfers, business-to-business (B2B) transactions, ATM transactions (e.g., cash withdrawals), and text message (SMS) and other social networking transactions.

### BRIEF DESCRIPTION OF THE DRAWINGS

FIG. 1 shows a flow chart illustrating a Business Entity (10) entering into an Agreement (40) with transaction system users (“participants”).

FIG. 2 shows a flow chart illustrating a possible financial transaction facilitated by the Business Entity (10) between two participants, where an Accounting Means (60) records the details of the transaction. In this example, Participant 1 uses the system to transfer money to Participant 2.

FIG. 3 shows a flow chart illustrating how the Business Entity (10) may collect fee-like contributions from the participants, record the details of the payments with the Accounting Means (60), and use an Allocation Means (50) to allocate portions of the contributions to a Charitable Entity (20) on behalf of each participant.

FIG. 4 shows a flow chart illustrating how the Business Entity (10) uses the Accounting Means (60) and Reporting Means (70) to report the charitable contribution made by each user of the transaction system, thereby allowing the users to obtain Tax Benefit (30) on their respective charitable contributions.

### DETAILED DESCRIPTION OF THE PREFERRED EMBODIMENT(S)

In the present invention, the business entity (10) could be a company that issues credit cards and debit cards, the charitable entity (20) could be a recognized charitable organization working to provide humanitarian aid. The participants (Transaction Participant #1, Transaction Participant #2) in a transaction could be a person holding a credit card (i.e., a cardholder) and a merchant who accepts credit cards for payment and is selling something the person wishes to buy. The Agreement (40) might specify that 80% of the merchant transaction fee on any purchase, as well as the cardholder's annual “card use” fee, and 100% of any interest and late payments the person makes on the credit card account would constitute donations or charitable contributions to the charitable entity (20). The card issuer (10) would process the transaction, determine the applicable fees, allocate (50) the agreed upon (40) fee portions to the charitable entity (20), and calculate (60) the portions of the fees that are tax deductible for each participant. The card issuer (10) could then report (70) these tax deductible amounts to the cardholder and merchant through their respective monthly billing statements, thereby allowing each to receive tax benefit (30) on their respective charitable contributions.

To understand how the present invention represents an improvement over a traditional affinity credit card system, some embodiments of the invention will be described.

A Traditional Affinity Card System works as follows: To obtain a traditional affinity credit card, a person (or corporation or government agency) enters into an agreement with a business entity or “card issuer” that issues the affinity credit cards. The agreement specifies that various fees will apply to the cardholder's use of the card for transactions. Examples include an annual card use fee (granting the cardholder the privilege of obtaining and using the credit card for one year), late payment fees (assessed when the cardholder fails to make a minimum required payment by a certain date), and interest (assessed to the cardholder when there is an outstanding balance on the credit card account).

When the credit card is used to make a purchase from a merchant, the merchant is charged a transaction fee by the business entity as well. This fee, also known as a merchant discount fee or blended rate fee, typically includes an interchange fee charged by the card issuing company, and one or more “acquirer” or “network” fees charged by the company that acquires and processes the transaction. In certain transaction systems, the card issuer also serves as the acquirer. In other transaction systems, the card issuer merely provides credit. The merchant may also be assessed other fees (e.g., “charge back” fees for disputed credit card charges and rental on card-swipe or “point-of-sale” devices). These fees are specified through agreements the merchant enters into with the card issuer and possibly with the acquirer company that may lease out the point-of-sale device and process the transaction.

For an affinity card system, in exchange for the cardholder's agreement to use an affinity credit card, the card issuing company agrees to make a small contribution (usually around 0.5% of the transaction value) to a nonprofit or charitable organization. This is generally achieved by yet another contractual agreement the card issuer enters into with the affinity organization. In exchange for agreeing to contribute this funding for the organization, the card issuer may obtain access to the organization's mailing or membership list for use in soliciting those persons to obtain the affinity credit card. The affinity organization itself may sponsor or participate in the credit card solicitations. Although the affinity organization may be recognized under applicable tax law as being eligible for tax deductions on contributions made to the program, this need not be the case. In some cases, affinity cards raise funds for organizations or companies that are not recognized as charitable under applicable tax laws. Suppose the affinity cardholder purchases a $100 item and the merchant transaction fee is 3%. The transaction fee will therefore be $3. Suppose, by agreement, the card issuer then contributes a 0.5% of the $100 transaction to the designated charitable organization. This will amount to a charitable contribution of $0.50. The affinity cardholder may have paid an annual card use fee (typically $25-70 per year) but that fee payment is not contributed to the affinity organization. Likewise, the cardholder may pay a late payment fee and interest on the $100 charge, possibly totaling more than $40, but those fees are not contributed to the affinity organization. For the typical cardholder, the total amount of charitable contributions raised by using the affinity card over the course of a year, through all transactions carried out with the card, may be less than $20. In contrast, the annual card use fee, interest charges, and other fees paid by the cardholder on that affinity card account may exceed $200. The cardholder might have been able to contribute much more to the desired charitable organization just by donating the value of the annual card use fee directly to the charity, and then opting to use a non-affinity credit card that carries no annual card use fee and is subject to a lower interest rate.

Another important realization is that because the affinity cardholder does not actually make any contributions to the charitable organization, the cardholder is not eligible for a tax benefit on any of the payment card fees he or she pays. Similarly, because the card issuer makes the contribution to the charitable organization, the merchant may not be eligible to claim a charitable tax deduction on any of the merchant transaction fee paid on the affinity card transaction. If the card issuer makes the contribution to the charitable organization, only the card issuer may claim a charitable tax deduction for that contribution.

In the present invention, the cardholders and merchants participating in credit card transactions can make donations to a charitable entity (20) through a variety of fees they agree (40) to pay on the transactions facilitated by the business entity (10). The participants can thereby contribute a greater amount to the charitable means (20) than they could through existing affinity card systems, and the participants may also be eligible for tax benefit (30) on those contributions.

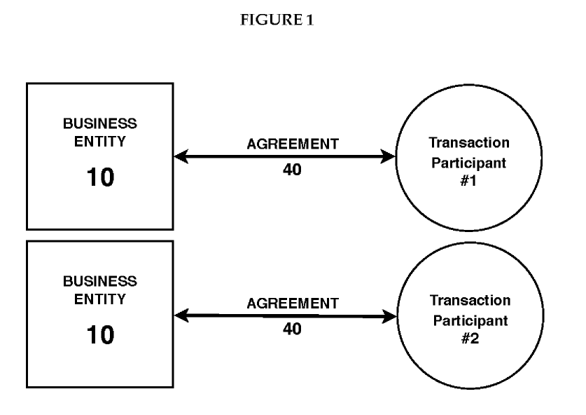

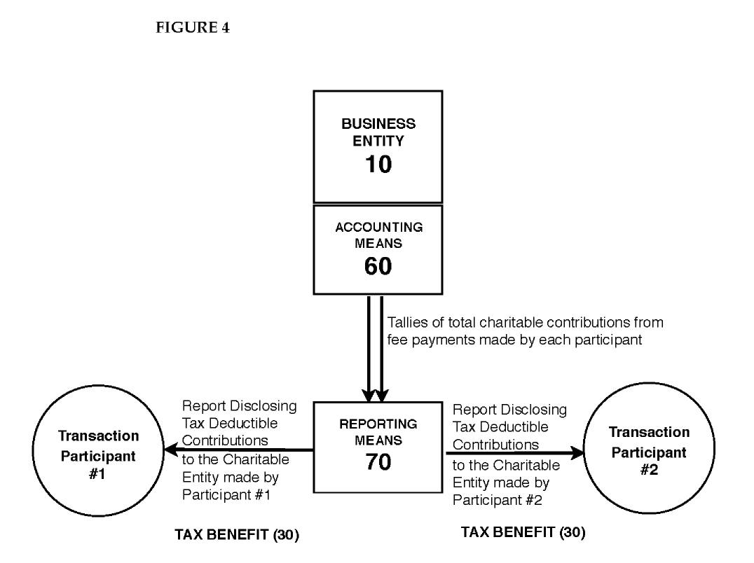

The present invention works as follows as an improved credit card system: A person wishing to obtain a credit card for use enters into agreement (40) with business entity (10) that issues credit cards. This is shown in FIG. 1, where the cardholder may be considered Participant #1. Unlike traditional affinity card systems, this agreement (40) specifies that some or all of the fees the cardholder pays through use of the system will constitute donations (i.e., charitable contributions) to the charitable entity (20) rather than payments to the business entity (10). For instance, rather than agreeing to pay an annual “card use” fee to the business entity (10), the credit cardholder agrees to make an annual donation, relayed through the business entity (10), to the charitable entity (20). For purposes of the present invention, when the term “relayed through the business entity (10)” is employed, the meaning is to be construed as money is not received as income by the business entity (10) in terms of business accounting practice, but rather money is collected and held and then passed to the charitable entity (20). This is illustrated in FIG. 3. Because the agreement (40) specifies the cardholder's annual fee will be used as a charitable contribution, the cardholder may therefore be eligible to claim that contribution as tax benefit (30) through the system, as shown in FIG. 4.

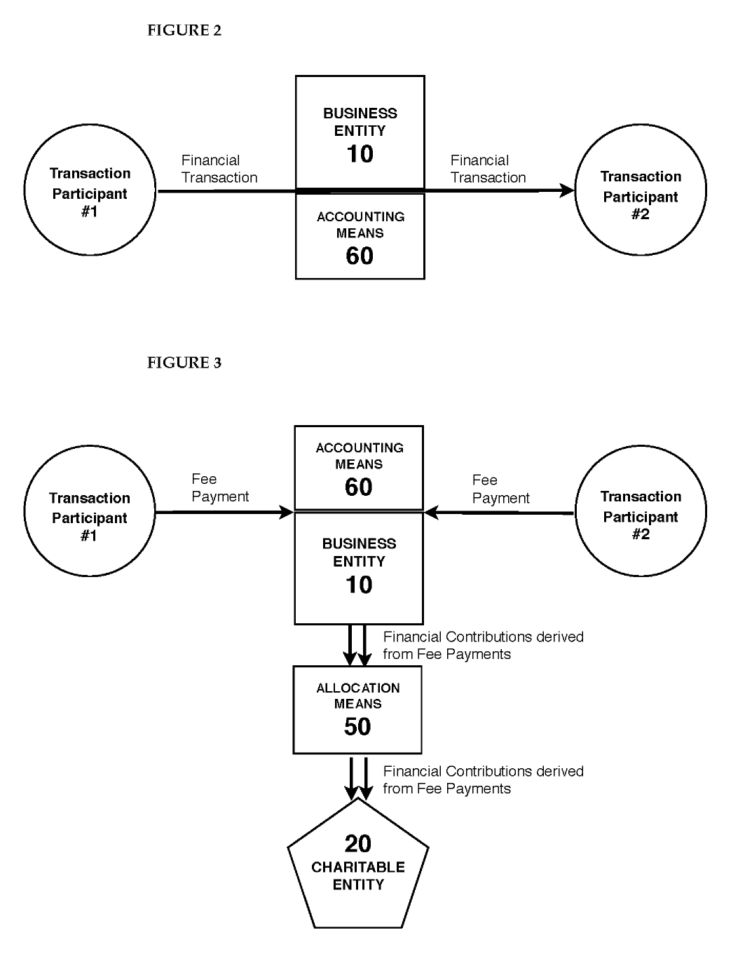

Another example is credit card interest. In an example of this invention, rather than agreeing to pay the business entity (10) traditional interest charges on an outstanding credit card account balance, the cardholder enters into an agreement (40) with the business entity (10) to make a contribution to the charitable entity (20) based on a percentage of the outstanding balance on the cardholder's credit card account. This percentage-based contribution may accrue like an interest charge but, by agreement (40), it is a charitable contribution the cardholder agrees to make to the charitable entity (20) rather than a traditional finance charge the cardholder would make to a non-charitable card issuer. The interest accrues on the cardholder's account balance originating from transactions such as those shown in FIG. 2 (where Participant #2 is a merchant that accepts credit cards for purchases). Because the agreement (40) specifies the percentage-based payment will be used as a charitable contribution, the cardholder may be eligible to claim that contribution as tax benefit (30), as shown in FIG. 4. Under existing U.S. tax laws, credit card interest payments are not tax deductible, not even when paid on traditional affinity card accounts. Because credit card interest is often the largest fee cardholders pay on the use of credit cards—with some cardholders accruing over $1000 in interest charges each year—this example of the invention illustrates a significant improvement over existing credit card systems, including affinity systems.

Another example is a credit card late payment fee. In traditional affinity card systems, the cardholder agrees to pay a late payment fee to the card issuer when the cardholder fails to make a minimum required payment on the outstanding credit card account balance by a specified date. The due date is typically 20-30 days after the cardholder is sent a bill by the card issuer. This late payment fee may range from $25-75. The cardholder pays this fee to a non-charitable card issuer, not to a charitable organization. Thus, the cardholder cannot obtain tax benefits from paying a late payment fee and receives no moral benefit in paying this fee, even if the credit card is an affinity card. In an example of the present invention, the cardholder and business entity (10) enter into an agreement (40) specifying that in the event the cardholder fails to make a minimum required payment by the agreed upon due date, the cardholder will make a specified financial contribution to the charitable entity (20). For instance, the agreement (40) may specify the late payment charitable contribution will be $25 for each instance where the cardholder fails to meet the payment deadline. In this example, the cardholder receives a moral benefit knowing any late payment fees will help charitable efforts. In addition, the cardholder can receive tax benefit (30), as shown in FIG. 4, because the late payment contribution constitutes a tax deductible contribution to a charitable organization.

Other examples of this invention allow contributions to a charitable entity (20) to be made from payments on credit card cash advance fees, balance transfer fees, out-of-country fees, and other conventional credit card fees. In a cash advance, the business entity (10) becomes Participant #1 shown in FIG. 2 and loans money directly to the cardholder (Participant #2). The invention allows any and all such traditional transaction-related fees to thereby become charitable contributions eligible for the tax benefit (30). In certain embodiments, the agreement (40) between the cardholder and the business entity (10) may specify that the business entity (10) can keep a portion of the fee payments to pay its operating costs, and then direct the remainder of the fee payments to the charitable entity (20). In such embodiments, only the portions of payments actually made to the charitable entity (20) qualify for the tax benefit (30), as shown in FIG. 4. This amount can be tracked through the accounting means (60) as shown in FIG. 3.

The present invention works as follows as an improved debit card system to raise charitable funding: A credit card allows a user to borrow funds to make a purchase or obtain a cash advance. A debit card, in contrast, uses the cardholder's own funds. There are different kinds of debit cards including, but not limited to, check cards, gift cards, prepaid cards (e.g., telephone calling cards), and payroll cards. The present invention can make use of all types of debit cards to raise charitable funding and convey tax benefits that are not possible through the use of traditional debit cards. As with a credit card, a debit card is typically subject to a variety of fees imposed by the company that issues the card. The fees include such things as transaction fees, cash advance fees, ATM fees, foreign (i.e., out of network) ATM fees, and overdraft fees. In traditional debit card systems, the debit cardholder pays these fees to the card issuer, usually a for-profit bank. The fee payments are not used to provide funding to a charitable organization.

The present invention allows such fee payments to be used as contributions to a charitable entity (20). This can be achieved in the same way as the charitable fund raising mechanism discussed in the foregoing examples related to charitable contributions made through a credit card. The cardholder and business entity (10) enter into an agreement (40), FIG. 1, specifying that various charitable contributions—from certain fees the cardholder pays in association with using the debit card—will be made to the charitable entity (20). Because the system allows the debit cardholder to allocate these contributions to the charitable entity (20), as shown in FIG. 3, the contributions are eligible for the tax benefit (30) and can be claimed as tax deductible charitable contributions as shown in FIG. 4. This allows the debit cardholder to achieve a moral benefit by contributing payments to the charity rather than to a non-charitable card issuer. This example also allows the debit cardholder to save money through the tax benefit (30). These benefits are not available with traditional debit card systems.

The present invention works as follows via Card Replacement Fees and Quid Pro Quo Contributions: A slightly more complex example of this invention is a credit or debit card replacement fee. When a payment card is lost or stolen, or if it is damaged so as to render the card unusable, the cardholder may contact the business entity (10) and request a replacement card. In traditional credit and debit card systems, the card replacement fee may be $10-20. The present invention can be used to turn such card replacement fees into charitable contributions. Unlike the contributions discussed above, in this case the cardholder will obtain something of measurable value in exchange for the contribution, namely a new card that must be produced and mailed to cardholder. This means the cardholder is receiving something of value in exchange for the fee. The U.S. tax code for charitable donations contains a provision referred to as the quid pro quo contribution rule. This rule, codified in Section 6115 of the U.S. Internal Revenue Code, specifies that if a person makes a contribution to a charitable entity, and if the person then receives something of value in exchange for the contribution, only the portion of the contribution in excess of the value of the good or service received can be claimed as a charitable contribution eligible for a tax deduction.

The cost to produce a new card and mail it to the cardholder may be $1. Suppose the cardholder and business entity (10) enter into an agreement such that, whenever a cardholder requires a new card, the cardholder will make a $10 charitable contribution in lieu of paying a traditional replacement card fee. If the cost of producing and mailing a new card to the cardholder is $1, then the net tax deductible contribution under the quid pro quo rule will be $9, not the full $10.

Similarly, when the cardholder and business entity (10) first enter into an agreement (40), there will be a cost associated with producing and delivering the first credit or debit card to the cardholder. Suppose the agreement (40) specifies the cardholder will make a charitable contribution of $25 per year as a “card use” fee for the privilege of using the payment card for the first year. Suppose further that the cost of producing and delivering the original card to the cardholder is $1. In this case, the quid pro quo rule specifies that only $24 of the first year “card use” contribution of $25 will be eligible for the tax benefit (30). In subsequent years, when the cardholder does not need a replacement card, the full $25 annual “card use” contribution may be eligible for the tax benefit (30).

Any other charitable contributions the cardholder agrees (40) to make, where such contributions are associated with a good or service having an identifiable value, will also be subject to the quid pro quo rule. This invention uses accounting means (60) to tally the tax deductible contribution from each participant's contribution that involves a valued good or service.

In various embodiments, the business entity (10) may use some of the payments made by the participants to pay for the business entity's operating expenses. In such embodiments, only the portion of the contribution that is used for charitable purposes, and is above the value of any goods or services provided, will be eligible for the tax benefit (30). The accounting means (60) and reporting means (70) are then structured to calculate and report the tax deductible charitable contributions.

The present invention works as follows via Merchant Fees: Another example of the invention relates to fees typically assessed to merchants in relation to payment card transactions. Consider an example where a cardholder uses a credit card to purchase a $100 item from a merchant. This is represented in FIG. 2, where the cardholder may be represented as Participant #1 and the merchant as Participant #2.

In a traditional affinity card (or other credit card) system, the merchant is charged a transaction fee (sometimes called a merchant discount fee or blended rate fee) that is usually proportional to the value of the transaction. Paying this fee is a contractual obligation that arises from an agreement the merchant enters into with the business entity (typically the card issuer or an “acquirer” that acquires and processes the credit card transaction). The merchant agrees to pay this fee because accepting credit and debit cards can lead to increased sales. Suppose the merchant transaction fee is 3% of the total value of the item purchased with a credit card. The transaction fee on the $100 purchase will therefore be $3. In a traditional affinity card and other credit card systems, the transaction fee is paid by the merchant to a business entity that manages the transaction. This fee may not be paid directly, but indirectly by the merchant agreeing to accept a discounted payment for the item sold (in this example the discount is 3% below the sale price, so the merchant only receives $97 on the $100 sale, just as if the cardholder paid the merchant $100 and the merchant then paid a $3 transaction fee). By paying the transaction fee, the merchant does not make a contribution to a charitable entity.

In the present invention, the merchant may enter into a different kind of agreement (40) with the business entity (10) such that—rather than agreeing to pay the business entity (10) a transaction fee when a payment card is used to make a purchase at the merchant's store—the merchant agrees to make a charitable contribution to the charitable entity (20), as shown in FIG. 3. Like a traditional transaction fee, this contribution can be scaled in proportion to the value of the transaction. The merchant can therefore gain a moral benefit in knowing the transaction fee contributions paid out will be used for charitable purposes. Moreover, because the transaction fee contributions will go to a charitable entity (20), the merchant can receive tax benefit (30) in that the contributions will be tax deductible, as shown in FIG. 4. These are significant advantages over traditional credit and debit card transaction fees.

Another example of an application of this invention is a merchant “charge back” fee. When a merchant authorizes a transaction that is later disputed—for instance, because the merchant inadvertently overcharged the cardholder or because the merchant approved the use of a credit card that had been stolen—the true cardholder can ask the card issuer to charge back the transaction to the merchant. This allows the cardholder to be reimbursed for the improper card charge. When this occurs with traditional credit card systems (including affinity card systems), the card issuer typically assesses the merchant a “charge back” fee that may range from $20-80. When the merchant pays a charge back fee, the fee is paid to the card issuer, not to a charitable entity.

In an example of the present invention, the merchant may enter into an agreement (40) with the business entity (10) establishing that some or all of each charge back fee will constitute a charitable donation made to the charitable entity (20) as shown in FIG. 3. The allocation means (50) then allocates this contribution to the charitable entity (20), and the accounting means (60) and reporting means (70) are used to track the contribution and report it back to the merchant for tax purposes. The merchant can thereby gain a moral benefit in knowing the charge back payment will be used for charitable purposes. Moreover, because the charge back contributions are going to a charitable entity (20), the merchant can receive tax benefit (30) on the contributions as shown in FIG. 4. These are significant advantages over traditional credit and debit card systems. In a similar fashion, any type of fee a merchant would normally pay on a traditional affinity credit card, non-affinity credit card, debit card or smart card can be transformed into a charitable contribution that offers the merchant the moral advantage and tax benefit (30).

The present invention works as follows as an Improved Electronic Transaction System: Many types of financial transactions are electronic in nature, such as wire transfers, electronic funds transfers, digital wallet transactions, e-cash and e-check transactions, and internet (e-commerce) transactions. In these systems, the business entity that facilitates the transaction assesses a fee for facilitating the transaction. In the traditional systems, one or both of the participants in the transaction pay a fee to the business entity. The fees paid to the business entity are not contributed to a charitable entity, so the participants cannot claim a tax deduction on those fees. An example of the present invention improves on this by having the participants in the transaction enter into an agreement (40) with the business entity (10), as shown in FIG. 1, such that in exchange for the business entity agreeing to facilitate the transaction, FIG. 2, one or both of the participants will agree to make a contribution to the charitable entity (20), as shown in FIG. 3. Because each contribution paid by the participant(s) through this system will constitute a charitable contribution, those contributions will be eligible for the tax benefit (30), as shown in FIG. 4.

The present invention works as follows as a payment card Transaction Processing (acquirer) system: The business entity (10) is set up to facilitate transactions that make use of traditional payment cards (which may be credit cards, debit cards, charge cards and smart cards, in the preferred embodiment) issued by a variety of card issuers. For instance, the business entity (10) could sell or manage point-of sale devices (i.e., card swipe machines) issued to merchants. The business entity can also acquire and process a payment card transaction on behalf of the card issuer. When a non-participating credit or debit card, such as a traditional credit card issued by a for-profit bank, is used for a transaction on one of these devices, the business entity (10) can assess a fee on the transaction that may be paid by the merchant. By agreement (40) between the merchant and business entity (10), FIG. 1, this fee can be used as a charitable contribution in the same way discussed above for other merchant transaction fees and as shown in FIG. 3. This example allows the business entity (10) to capture charitable contributions from the use of payment cards that are not issued by the business entity (10) and which would otherwise not generate any charitable contributions or tax benefit (30) for the merchant. Relating this example to FIG. 1, only the merchant (Participant #2) enters into an agreement with the business entity (10). The business entity (10) still facilitates transactions between the merchant and credit cardholders (indicated as Participant #1). This is illustrated in FIG. 2 where the merchant is designated Participant #2 and the cardholder is designated Participant #1. However, in this example the cardholder does not participate in the system through any agreement (40). Moreover, that cardholder may not pay any fee to the business entity (10) for allocation to the charitable entity (20). In this case, although the participating merchant can obtain the tax benefit (30) on the fees it contributes through use of the transaction system, the non-participating cardholder is not subject to the allocation process shown in FIG. 3 or the reporting process shown in FIG. 4. So the nonparticipating cardholder cannot receive any tax benefit (30).

In the forgoing examples of this invention, the agreement (40) between the business entity (10) and a participant using the transaction system specifies the terms for how charitable funds will be raised from transaction-related fees. By specifying that the participants are the parties making the charitable contributions, the agreement (40) also allows the participants to become eligible for tax benefit (30) on those contributions. However, to manifest the charitable contributions and tax benefits, the invention makes use of additional means discussed below, and without each of these elements, the tax benefit (30) would not be possible.

The present invention works as follows as an Allocation Means: To achieve the tax benefit (30), the present invention uses allocation means (50) to ensure the financial contributions each participant in the transaction system agrees (40) to make are, in fact, contributed to the charitable entity (20). In a traditional affinity card system, the card issuer may make contributions to a charitable organization based on the monetary value of transactions carried out with the affinity card. These contributions can be made by the card issuer to the charitable entity via electronic transfer or other means of monetary exchange. This method of fund allocation is not sufficient to achieve the tax benefit (30) of the present invention because it does not achieve a financial connection between the transaction participants and the charitable entity (20). An embodiment of this invention that makes the necessary connection is for the agreement (40), FIG. 1, to specify that each participant will issue a payment (e.g., check)—in the amount of the total charitable contributions accrued through the credit card transactions—directly payable to the charitable entity (20) rather than to the business entity (10).

Alternatively, the agreement (40) may specify that a participant (e.g., cardholder or merchant) will issue a payment to the business entity (10) in the amount of the total charitable contribution, and the business entity (10) will then relay that contribution on to the charitable entity (20) for the participant. The participant can make payment to the business entity (10) using a check, money order, electronic transfer, or other means of monetary exchange. In this example, the business entity (10) merely acts as a conduit or relay between the participant to the charitable entity (20). This is illustrated in FIG. 3. This allocation means (50) is preferable because it allows the business entity (10) to confirm each participant honors the agreement (40) to make the specified contribution amounts to the charitable entity (20).

The present invention works as follows as an Accounting Means: Another element of the present invention needed to manifest the tax benefit (30) is accounting means (60) for accurately tracking how much of each participant's contributions to the charitable entity (20) will be eligible for the tax benefit (30). This is illustrated in FIG. 3. If a cardholder (or merchant) made only one contribution in a given year—and if that contribution were fully charitable rather than involving a quid pro quo good or service—there would be no need for accounting means. However, when a transaction system is used for charitable fund raising, as in this invention, a participant (e.g., cardholder, merchant, B2B company, or text message user) may engage in many different transactions in a given year, and the charitable amount of each of these contributions must be accurately tracked in order to determine the net annual tax benefit (30).

In traditional transaction systems—including those with transactions involving standard credit cards, affinity credit cards, debit cards, and electronic means (e.g., wire transfers)—the business entity facilitating the financial transactions maintains a record of each transaction. This record may store information about the date and amount of the transaction as well as identification information (e.g., names, addresses and account numbers) of the participants to the transaction.

These records are maintained in a computer database. The database may also maintain a record for each participant, specifying such things as the dates and amounts of all transactions the participant has engaged in, and the amounts of fees the participant will be expected to pay. An embodiment of the present invention also uses a computer database to store information about each participant and each transaction in which he or she participates. In this invention, however, additional accounting means (60) may be used to calculate the tax deductible contribution of each transaction related payment, which requires subtracting off the quid pro quo value of any associated good or service (e.g., card replacement fee). This is represented in FIG. 3. The accounting means (60) in this invention may also be used to tally the total charitable contributions made by each participant to the charitable entity (20). These features of the accounting means (60) are not used in existing systems for credit cards, affinity cards, debit cards or electronic transactions.

As an example of how the invention can make use of the accounting means (60), suppose that over the course of an entire year a particular credit cardholder makes three different purchases from the same merchant, as represented in FIG. 2, where each purchase value is $100 and is subject to a $3 merchant transaction fee. Suppose that by agreement (40), the cardholder commits to make an annual “card use” contribution is $30. Suppose also that same year the cardholder makes one $25 late payment contribution through the system (FIG. 3) and also makes an interest-type charitable contribution of $12 (FIG. 3) for failing to pay the account balance off in full by the specified deadline. Suppose further the cardholder loses the original credit card and requires a replacement, subject to a card replacement contribution of $10 (FIG. 3), where $1 of this is the cost of producing and mailing the new card to the cardholder. These transaction data will be stored in a computer database maintained by the business entity (10).

The accounting means (60), established through computer software that can access the database, would tally each of these contributions and determine that this cardholder has made a net annual contribution of $77 ($30 card use fee, $25 late payment fee, $12 interest, $10 card replacement fee) to the charitable entity (20). However, the accounting means (60) would also determine that only $76 of this will be tax deductible due to the quid quo pro rule and the $1 value of providing the replacement card. At the same time, the accounting means (60) registers in the computer database (FIG. 2) that the merchant participated in three different $100 transactions using the charitable transaction system. If the merchant entered into an agreement (40) to pay a transaction fee contribution equal to 3% of the transaction amount, the accounting means (60), FIG. 3, would determine the merchant in this example has made $9 ($3+$3+$3) in tax deductible contributions to the charitable entity (20) for the year. Since none of the transaction fees is associated with a quid pro quo good or service, the accounting means (60) records that the full amount of these fees paid by the merchant will be eligible for the tax benefit (30). All applicable fees for the participants, as well as any quid quo pro value can be stored in the database thereby allowing automated calculation of the contributions associated with any use of the financial transaction system.

As another example, suppose that in one year a person makes three $100 money transfers using an electronic transaction system, such as a wire transfer, that incorporates the present invention. Each transaction would be represented by FIG. 2. Suppose, by agreement (40), FIG. 1, each financial transaction is subject to a charitable contribution of 4% of the transaction amount. The accounting means (60) (FIG. 2) would maintain a record of these transactions for the participant and tally the total contribution (FIG. 3) the person has made to the charitable means (20). In this case, the net annual charitable contribution for the transfers will be $12, and the accounting means (60) would record that there are no quid pro quo goods or services to deduct.

The present invention works as follows as a Reporting Means: The present invention also uses reporting means (70) to manifest the tax benefit (30). Under existing tax law, in order for a party to claim a tax benefit from a charitable donation, the party must be provided with a statement documenting the total amount of charitable contributions the party has made during the taxable year to a recognized charitable entity. Section 6115 of the U.S. Internal Revenue Code further provides that when a quid pro quo contribution in excess of $75 is made to a charitable organization, the contributor must be provided with a written disclosure statement. The written disclosure statement must inform the contributor that the amount of the contribution which is deductible for federal income tax purposes is limited to the excess of any money (and the value of any property other than money) contributed by the donor above and beyond the value of the goods or services provided by the charity. The statement must also provide the contributor with a good-faith estimate of the value of the goods or services that the donor received. The written disclosure must be presented in a manner that is reasonably likely to come to the attention of the donor. In addition, Section 6115 of the tax code provides that separate payments of $75 or less, made at different times of the year for separate fund raising events, are not aggregated for purposes of the $75 threshold. As an example of how these requirements apply to the present invention, the accounting means (60) can tally the total tax deductible contribution each participant has made for the year to the charitable entity (20), as shown in FIG. 3. However, to realize the tax benefit (30), the participant may need to be provided with a written statement disclosing this sum. This is why the present invention comprises reporting means (70).

An embodiment of the present invention uses a printed statement, transmitted to each participant at the end of the taxable year, to serve as the reporting means (70) for disclosing the total tax deductible charitable contribution the participant has made to the charitable entity (20) for the year. This is illustrated in FIG. 4. Through the use of the accounting means (60), this statement also presents a good-faith estimate of the value of any goods or services the participant received in exchange for the contribution. As may be permitted by law, this statement may, for instance, be transmitted to the participant on paper by regular postal mail, in electronic form via email, or by other means.

In conventional credit card systems, as well as affinity card systems, the business entity provides each participant with a periodic billing statement that discloses details about each of the transactions the participant has engaged in through the system during the previous billing period. A statement is typically provided to each participant on a monthly basis. An embodiment of the present invention uses a similar periodic billing statement to further report the contribution the participant has made to the charitable entity (20) during the billing period as well as year-to-date contributions. The statement also provides a good faith estimate of the value of any quid pro quo goods or services that are not tax deductible. This information is obtained using the accounting means (60). The periodic billing statement thereby serves as the reporting means (70). The final billing statement of the taxable year can report to each participant the total charitable contribution the participant has made to the charitable entity (20) for that entire year. This year-end statement also provides the net value of any quid pro quo goods or services provided to the participant during the year. The statement may have one or more tear-away portions—documenting the net charitable contribution for the year—allowing the participant to remove that portion of the statement and then provide it to an accountant and/or to the appropriate tax agency. Although Section 6115 of the U.S. tax code does not require reporting of separate contributions that are less than $75, the reporting means (70) may nevertheless disclose such contributions.

In another example of the invention, the reporting means (70) can also make use of an on-line disclosure system whereby a participant may use the internet to access a secure webpage that reports the participant's transactions and charitable contributions made through the payment of transaction related fees. At present, however, this electronic disclosure alone will not satisfy the reporting requirements of the Internal Revenue Code because it does not amount to a written disclosure statement. The present invention will still function if the tax code is changed to so that quid pro quo disclosure statements can be provided electronically rather than in writing. This is because the reporting means (70) can be structured to accommodate any new reporting requirements that may be imposed through the tax code.

The present invention works as follows per Tithing Contributions: The present invention uses means to raise charitable “tithing” donations from the participants. Beyond the fee-type contributions specified in the agreement (40), a participant in the system may be asked to make a periodic (e.g., monthly or yearly) contribution to the charitable entity (20) that has no relationship to any other transactions the participant carry out using the system. For example, when a credit cardholder is sent a monthly billing statement on his or her card account, the statement can ask the cardholder to agree to make a $10 additional contribution each month to the charitable entity (20). These tithing contributions would be voluntary and would be above and beyond the contributions the participant agrees to make for various uses of the transaction system. The tithing contributions can nevertheless be made through this system in the way shown in FIG. 3. Because the entirety of all tithing contributions would be used exclusively for charitable purposes, they would be eligible for the tax benefit (30) without any quid pro quo reduction. The accounting means (60) and reporting means (70) can be structured to tally and report these additional contributions, as shown in FIG. 4. In this example, the accounting means (60) would sum the monthly $10 tithing contributions and determine the total yearly tithing to the charitable entity (20) is $120, all of which is eligible for the tax benefit (30). The reporting means (70) would then provide the participant with a written statement of these contributions, along with any others the participant may have made through the charitable transaction system.

The present invention works as follows per Emergency contributions: Embodiments of the invention can readily facilitate charitable contributions from the participants for emergency needs. For instance, if a hurricane strikes a coastal area and the people living in the area require emergency disaster relief, the business entity (10) can ask each participant (e.g., credit or debit cardholder and participating merchant) to make a special voluntary “emergency” contribution to the relief effort. This request can be made through the periodic billing statement or through special mailings, emailings, telephone calls, internet publications or other means. Such emergency contributions can be made through this system in the way shown in FIG. 3. Suppose a credit cardholder decides to make a $30 emergency contribution. The cardholder may include this contribution with his or her payment made in response to the periodic billing statement. Because the emergency contributions would be used exclusively for charitable purposes, they would be fully eligible for the tax benefit (30) without any quid pro quo reduction. The accounting means (60) and reporting means (70) can be structured to tally and report these additional charitable contributions, as shown in FIGS. 3 and 4.

In one preferred embodiment of the present invention, the business entity (10) is itself incorporated as a charitable organization under the tax code and therefore also serves as the charitable entity (20). For instance, the business entity may conduct charitable humanitarian aid or wildlife conservation programs. In this embodiment, the business entity (10) and the charitable entity (20) are one and the same, even though FIG. 3 shows them as separate. In this embodiment, the business entity (10) can also operate as a charitable foundation by providing some or all the funds it raises through the transaction system to other recognized charitable organizations. When the business entity (10) is also the charitable entity (20), the allocation means (50) are simplified so that the participant contributions to the charitable entity (20) are the same as the payments made to the business entity (10). The agreement (40), FIG. 1, can also be simplified because it will no longer be necessary for the agreement (40) to specify that contributions will be allocated to a charitable entity (20); this will be implicit in the embodiment. Even so, for clarity and to reassure participants, the agreement (40) may still specify that any contributions made through the system will be used for charitable purpose.

In this embodiment of the invention, the business entity (10) is set up to issue payment cards (which may be credit cards, debit cards, and smart cards). The business entity issues these cards to consumers, corporations, and government agencies for use in their day-to-day transactions. FIG. 2. A party (“cardholder”) desiring to obtain a charitable payment card from this business entity (10) would enter into an agreement (40) with the business entity (10). FIG. 1. However, rather than specifying that the cardholder will pay various fees for use of the payment card for transactions, the cardholder enters into an agreement (40) with the business entity (10) specifying that various charitable contributions will be made by the cardholder in exchange for the cardholder's use of the credit card. FIG. 3. These fees may include, but are not limited to, an annual “card use” contribution, an interest-type contribution on outstanding balances, late payment contributions, cash advance contributions, over-limit and over-draft contributions, and balance transfer contributions (i.e., a charitable contribution is made when the cardholder transfers debt from another credit card account to the charitable credit card account). Basically, for any type of fee a traditional payment card company assesses, there is a corresponding charitable contribution in this embodiment. For instance, rather than paying an annual “card use” fee to a for-profit credit card issuer, the cardholder provides an annual “card use” contribution to the charitable entity (20). Likewise, rather than agreeing to pay a for-profit card issuer interest on an outstanding balance, the person agrees to make a charitable contribution to the charitable entity (20) based on a percentage of the outstanding balance on the cardholder's credit card account. Because the cardholder's contributions will be made to a recognized charity (20), the cardholder will be eligible to claim those contributions as tax deductions (30).

In this preferred embodiment, the business entity (10) is also set up to also facilitate electronic transactions, FIG. 2, such as business-to-business (B2B) transfers, bank and wire transfers, internet transactions, escrow and text message (SMS) transactions. In this embodiment, the business entity (10) is also set up to act as an acquirer and issue and manage point-of-sale devices that can be used by merchants to allow transactions by a variety of credit and debit cards, including cards not issued by companies other than the business entity (10). When one of these “foreign” credit or debit cards is used for a transaction, the business entity (10) assess a fee on the transaction, paid by the merchant. By agreement (40), see FIG. 1, however, this fee is used as a charitable contribution from the merchant to the charitable entity (20), see FIG. 3. The fee payment would then be eligible for the tax benefit (30), FIG. 4, even though the “foreign” payment card may have no charitable affiliation or means.

In this preferred embodiment, the business entity (10) uses a computer system with a database containing records for all participants. The computer system also provides for the accounting means (60). This computer system tracks all the transactions of each participant and calculates which portion of each contribution is tax deductible under quid pro quo rules. The computer system stores a table of transaction contributions or “fees” along with information about each fee's specific quid pro quo value. For example, this table may have an entry recording there is a late payment fee of $25, which does not have any associated goods or services of value under the quid pro quo rules, so the table would record that the full $25 is eligible for the tax benefit. The database table may have another entry recording that there is a card replacement fee of $10, where this has a quid pro quo value of $1 for producing and mailing a new card. Whenever a participant (e.g., cardholder) engages in a transaction, FIG. 2, or related activity that, by agreement (40), is subject to a contribution (e.g., late payment), the computer system registers this transaction or activity, accesses the fee table, and then determines the size of the contribution, FIG. 3, and any quid pro quo value that may apply. The computer system then stores this information in the database record for that participant.

In this preferred embodiment, the business entity (10) provides each participant with a yearly statement presenting the participant with information about all the transactions the participant carried out during the year. FIG. 4. For credit and debit card transactions, the embodiment further provides monthly billing statements. The monthly billing statement for a given participant is produced by accessing the database record for the participant and summing all contributions the participant will be asked to make, as per the agreement (40). The monthly billing statement instructs the participant to pay this contribution—along with any outstanding balance (e.g., credit card debt outstanding or incurred during the billing period) by the specified payment due date. In the event the participant does not pay the entire outstanding balance (including charitable contributions) by the specified due date, the agreement (40) specifies that the participant will make an interest-type charitable contribution to the charitable entity (20). The interest contributions due are calculated by the accounting means (60) using interest rates stored in the database fee table.

Upon receipt of payment from a participant, see FIG. 3, the business entity (10) uses the accounting means (60) to record the payment in the computer database entry for the participant's account and to calculate the amount of charitable contributions resulting from that payment. The charitable contributions paid by the participant are then used by the business entity (10)—which, in this case, is also a charitable entity (20)—for charitable purposes, such as providing humanitarian aid, providing disaster relief, or funding wildlife conservation efforts. Because the business entity (10) also serves as a charitable entity (20) in this embodiment, the charitable contributions are tax deductible (30).

Each billing statement also informs the participant of the total charitable contributions the participant made during the billing period, year-to-date, and since the participant first joined into the charitable transaction system. This also includes a disclosure of good faith estimates of the value of any quid pro quo goods or services provided to the participant during the billing period. The yearly statement is the billing statement for the final billing period of the taxable year. This statement provides several separate or detachable portions that inform the participant of the total charitable contribution the participant made to the charitable entity (20) for that taxable year, along with any quid pro quo values subtracted off as not tax deductible. These tear-away portions of the billing statement can be used variously for the participant's personal tax records, for the participant's accounting, and for filing the participant's tax forms.

In this preferred embodiment, the business entity (10) also maintains a website that allows each participant to log on to his or her payment card account securely to receive a report on the current outstanding balance, to review any charges made previously on the account, to review all fees paid, and to examine the charitable contributions the participant has made to the charitable means (20) through the system.

In this preferred embodiment, each merchant who wishes to participate in the charitable transaction system enters into an agreement (40), FIG. 1, with the business entity (10). The agreement (40) specifies that the merchant agrees to accept for customer purchases the payment cards issued by the business entity (10) and, as applicable, electronic or other transactions facilitated by the business entity (10). The merchant agrees (40) to make a charitable contribution of a specified amount to the business entity (10) for each transaction involving a payment card issued by the business entity (10). See FIG. 3. The merchant also agrees to make a charitable contribution for any other type of transaction (e.g., electronic or internet transaction) facilitated by the business entity (10). For example, the agreement (40) may specify the merchant make a contribution 2% of the total transaction amount (not including sales tax) for each such transaction. In this embodiment, the agreement (40) also establishes that the merchant will make a charitable contribution of a specified amount in lieu of a charge back fee when a credit card charge is disputed. The agreement (40) may further specify that the merchant use a point-of-sale device or other payment card reader provided by the business entity (10), and this device may be used to process transactions using payment cards issued by companies other than the business entity (10). The agreement (40) also establishes that the merchant will make other charitable contributions (e.g., point of sale device rental) to the charitable entity (10) in lieu of standard fees that might be charged by a traditional transaction company.

As it does for each cardholder, the business entity (10) also maintains a computer database record for each participating merchant. A merchant's record stores information about each transaction made by that merchant, FIG. 2, along with the quid pro quo value of any good or service associated with the transaction, FIG. 3. The business entity (10) uses accounting means (60) to accurately track the transactions, FIG. 2, entered into by each participating merchant. The accounting means (60) also accurately tracks the charitable contributions, see FIG. 3, each participating merchant makes through the charitable transaction system. In this preferred embodiment, this system can be the same computer system with database and accounting means that is used to track cardholder transactions and contributions. For the reporting means (70), the business entity (10) sends each participating merchant a periodic billing statement, see FIG. 4, specifying any outstanding balance the merchant owes and further disclosing the total charitable contributions the merchant has made to the charitable entity (20) through the transaction system. At the end of the taxable year, the final billing statement issued to the merchant, see FIG. 4, by the business entity (10) reports (70) the total charitable contributions the merchant made to the charitable entity (20) during that taxable year. In accordance with the tax code, this statement includes a good faith estimate of the value of any goods or services the merchant may have received in exchange for the various contributions it has made to the charitable entity (20). This statement can be used by the merchant for tax accounting, tax filing and business records. Traditional affinity credit card systems do not include such reporting means and therefore do not offer merchants or other transaction participants a charitable tax benefit (30).

In this preferred embodiment, the business entity (10) also asks cardholders, merchants, and other transaction participants to make periodic “tithing” donations along with payment on their billing statements, as shown in FIG. 3. This can be achieved by including a fill-in box on the billing statement return stub which allows the participant to enter a monetary value the participant agrees to contribute (tithe) during each monthly billing period. This preferred embodiment also includes means that allow each participant to make an emergency donation in response to natural disasters and other urgent situations. This can also be achieved, as in FIG. 3, by including a fill-in box on the billing statement return stub which allows a participant to enter a monetary value which the participant agrees to contribute for the “emergency” need, on a one-time basis. The accounting means (60) tallies all of these contributions and reports (70) them, see FIG. 4, in the periodic and end-of-year statements, in accordance with the applicable reporting requirements of the tax code. This allows the tithing and emergency contributions to be eligible for the tax benefit (30).

This preferred embodiment also allows emergency, tithing, and other charitable contributions to be made at any time by any person through a secure website administered by the business entity (10). These contributions are tracked by the accounting means (60) and reported (70) in the periodic and end-of-year statements.

The present invention works as follows per online auction transactions: In an embodiment of the present invention, the business entity (10) facilitates online auctions. Each user who participates in the auctions, either by selling goods or buying goods, enters into an agreement (40) to make contributions to the charitable entity (20) in lieu of fee payments on the auction. The business entity (10) may collect the contributions from the users and, with the allocation means (50), relay the funds to the charitable entity (20). Then, the business entity (10) uses the accounting (60) and reporting (70) means to allow the user to attain a tax benefit on these contributions.

The present invention works as follows per advertising payment transactions: In an embodiment of the present invention, the business entity (10) manages payments on advertising for other parties (e.g., businesses). In traditional advertising systems the parties pay a fee for advertising, but the fees are not allocated to a charitable entity and do not yield a tax benefit. In the present invention, a party wishing to advertise enters into an agreement (40) to make a contribution to the charitable entity (20) for some or all of the usual advertising fee. The business entity (10) collects the agreed upon contribution from the party and uses the allocation means (50) to relay the funds to the charitable entity (20). The business entity (10) then uses the accounting (60) and reporting (70) means to allow the party to attain a tax benefit on the party's advertising contributions.

The present invention works as follows per digital file purchasing transactions: In an embodiment of the present invention, the business entity (10) manages transactions involving the purchase of digital files, such as digitized songs, images or movies. A user wishing to purchase a digital file pays a fee for the file and also pays a fee for the transaction that makes the purchase possible. The user agrees (40) to contribute some or all of the transaction fee to the charitable entity (20). The business entity (10) then collects the agreed upon contributions from the user and uses the allocation means (50) to relay the funds to the charitable entity (20). Finally, the business entity (10) uses the accounting (60) and reporting (70) means to allow the party to attain a tax benefit on the transaction fee paid on the digital file purchase.

It should be understood that the present invention is a transaction system for charitable fundraising from a user, having:

a business entity (10) that facilitates financial transactions;

a charitable entity (20) that is recognized under applicable tax law as being eligible for tax benefits (30) on financial contributions made to said charitable entity (20);

an agreement (40), between said business entity (10) and the user, specifying that the user will make charitable contributions to said charitable entity (20) via said financial transactions of said business entity (10), said charitable contributions collected and not received as income by said business entity (10) unless said business entity (10) is said charitable entity (20);

allocation means (50) for dispersing to said charitable entity (20) said charitable contributions made by the user in accordance with said agreement (40);

computer accounting means (60) for tracking said charitable contributions that the user makes to said charitable entity (20) via said allocation means (50), said charitable contributions being eligible for a tax benefit (30); and

reporting means (70) for disclosing said charitable contribution to said charitable entity (20) via said allocation means (50), said charitable contribution eligible for a tax benefit (30). Further, present invention also has payment cards issued by said business entity (10). Additionally, the present invention has financial transactions that are payment card financial transactions processed by said business entity (10). Also, the present invention has said business entity (10) set up to act as an acquirer. Moreover, the present invention has said financial transactions as payment card financial transactions wherein credit is provided by the business entity (10) on said transactions. Even still, the present invention has said financial transactions being wire transfers processed by said business entity (10). Still, the present invention has said financial transactions being electronic funds transactions processed by said business entity (10). As well, the present invention has said financial transactions being e-commerce transfers processed by said business entity (10). Additionally, the present invention has said financial transactions being electronic bill presentations and payments processed by said business entity (10). Also, the present invention has said financial transactions being financial securities trades processed by said business entity (10). Further, the present invention has said financial transactions as currency trades processed by said business entity (10). As well, the present invention has said financial transactions as online auctions processed by said business entity (10). Moreover, the present invention has said financial transactions as loans issued by said business entity (10). Even still, the present invention has said financial transactions being digital file purchases processed by said business entity (10). Additionally, the present invention has checks managed by said business entity (10). As well, the present invention has tithing donations from the user to said charitable entity (20). Also, the present invention has said financial transactions through telecommunications text messages processed by said business entity (10). Further, the present invention has said financial transactions as advertising payments processed by said business entity (10). Additionally, the present invention has point-of-sale devices provided by said business entity (10). As well, the present invention has said business entity (10) and said charitable entity (20) being one in the same.

The present invention should not be construed to be just that which has been described above, as the present invention is also any and all of the following claims.

I claim:

1. A transaction system for charitable fund raising from a user, comprising:
a business entity (10) that facilitates financial transactions;
a charitable entity (20) that is recognized under applicable tax law as being eligible for tax benefits (30) on financial contributions made to said charitable entity (20);
an agreement (40), between said business entity (10) and the user, specifying that the user will make charitable contributions to said charitable entity (20) via said financial transactions of said business entity (10), said charitable contributions collected and not received as income by said business entity (10) unless said business entity (10) is said charitable entity (20);
allocation means (50) for dispersing to said charitable entity (20) said charitable contributions made by the user in accordance with said agreement (40);
computer accounting means (60) for tracking said charitable contributions that the user makes to said charitable entity (20) via said allocation means (50), said charitable contributions being eligible for a tax benefit (30); and
reporting means (70) for disclosing said charitable contribution to said charitable entity (20) via said allocation means (50), said charitable contribution eligible for a tax benefit (30).

2. The system of claim 1, further comprising payment cards issued by said business entity (10).

3. The system of claim 1, wherein said financial transactions are payment card financial transactions processed by said business entity (10).

4. The system of claim 1, wherein said business entity (10) is set up to act as an acquirer.

5. The system of claim 1, wherein said financial transactions are payment card financial transactions wherein credit is provided by the business entity (10) on said transactions.

6. The system of claim 1, wherein said financial transactions are wire transfers processed by said business entity (10).

7. The system of claim 1, wherein said financial transactions are electronic funds transfers processed by said business entity (10).

8. The system of claim 1, wherein said financial transactions are e-commerce transactions processed by said business entity (10).

9. The system of claim 1, wherein said financial transactions are electronic bill presentations and payments processed by said business entity (10).

10. The system of claim 1, wherein said financial transactions are financial securities trades processed by said business entity (10).

11. The system of claim 1, wherein said financial transactions are currency trades processed by said business entity (10).

12. The system of claim 1, wherein said financial transactions are online auctions processed by said business entity (10).

13. The system of claim 1, wherein said financial transactions are loans issued by said business entity (10).

14. The system of claim 1, wherein said financial transactions are digital file purchases processed by said business entity (10).

15. The system of claim 1, further comprising checks managed by said business entity (10).

16. The system of claim 1, further comprising tithing donations from the user to said charitable entity (20).

17. The system of claim 1, wherein said financial transactions are through telecommunications text messages processed by said business entity (10).

18. The system of claim 1, wherein said financial transactions are advertising payments processed by said business entity (10).

19. The system of claim 1, further comprising point-of-sale devices provided by said business entity (10).

20. The system of claim 1, wherein said business entity (10) and said charitable entity (20) are one in the same.
